(19) United States
(12) Patent Application Publication
(10) Pub. No.: US 2002/0097634 A1
(43) Pub. Date: Jul. 25, 2002

(54) Gas lift bio-reactor designs

(76) Inventors: Phyllis Heather Pilkington, London (CA); Normand Anthony Mensour, London (CA)

Correspondence Address: JAMES W. KERR, LABATT BREWING COMPANY LIMITED, 303 RICHMOND STREET, LONDON, ON, N6B 2H8, CA

(21) Appl. No.: 09/767,866

(22) Filed: Jan. 24, 2001

(51) Int. Cl. B01F 5/06

(52) U.S. Cl. 366/337

(57) ABSTRACT

A reactor (and especially a gas-lift reactor, and even more especially a bio-reactor, such as a fermentor) includes a static mixer arranged in a re-circulating reactor flow. The static mixer comprises a longitudinally elongated conduit having tabs that are arranged with respective first edges adjacent the conduit wall, and respective opposed second edges that are spaced radially inwardly from the conduit wall. These tabs are operable as fluid foils so that with fluid flowing through the conduit, greater fluid pressures manifest against the tab's upstream faces relative to reduced fluid pressures against their downstream faces. The resultant pressure difference in the fluid adjacent, respectively, the mutually opposed faces of each of the tabs causes a longitudinal flow of fluid through the conduit over and past each said tab, to be redirected. As a result of that redirection, there is introduced a radial cross-flow component to the longitudinal flow of fluid through the conduit. In particular, the reactor further comprises a draught tube (e.g. housing a co-operative, re-circulating conduit) extending generally co-axially along at least a portion of the longitudinal extent of the conduit and defining between the central body's surface and the conduit wall, an annular space confining the radial cross-flow. A method is also disclosed, which comprises static mixing, over a longitudinal extent of a mixing volume having an annular cross-section, wherein radial cross-stream mixing in a longitudinal fluid flow results from flow-redirecting tabs redirecting a longitudinal fluid flow from an outer, fluid containment boundary surface, across an intervening space having an annular cross-section towards an inner boundary surface.

### FIELD OF THE INVENTION

The present invention relates to improvements in gas-lift bioreactors, and in particular to improvements related to the installation of static mixing elements in return (typically a down-comer) flow within the such reactors, and especially to improved gas-lift bioreactors in which static mixing elements induce radial cross-flows within a longitudinal return flow through an elongated fluid-mixing conduit within the thus equipped gas-lift bioreactor.

### BACKGROUND OF THE INVENTION

Gas-lift bioreactors provide mixing within the riser flow (typically within a central draft or draught tube) into which uplift gas is sparged.

Under certain specialised circumstances, additional draught tube mixing has been suggested. In an article appearing in The Canadian Journal of Chemical Engineering, Volume 77, June 1999, (Vincente, Dluhy, and Teixeira, pages 497 through 502), the use of a series of multiple turbine-like static mixer elements in an air-lift ethanol fermentor is disclosed. The stated function of the draught tube mixing elements is to increase shear stresses within the draught tube (also referred to as the riser), in order to decrease the average floc size, and to increase mixing characteristics and mass transfer rates as opposed to significantly increasing the air-flow rate. Deploying the mixers within the draught tube, however, results in mixing in the three-phase region of the reactor—which is not always desirable, as for example in fermentations where increased gas-solubilization is not an objective (which is a factor, for example, that distinguishes fuel ethanol production from beer production, or otherwise when the predominant reactor efficiency issue is concerned with solid/liquid phase mass transfers). Moreover, combining the shear effects of the static mixers and the floc disruption of the gas-injection induced mixing to produce sufficient force to reduce floc size is not always the best way to optimise fermentation outcomes. In addition the turbine stype mixing rings illustrated in the article induce a generalized spin or twist into the “plug” flow exiting it, rather than inducing an ongoing downstream mixing within the exiting flow. Moreover, the centrifugal forces that result fomr such generalized spining action may actually spin out the floc yeast—in effect making the liquid/solid dispersion less uniform in the spaces between the mixing rings.

### SUMMARY OF THE INVENTION

Mixing in the return tube (e.g. the down-comer) flows of gas-lift bioreactors, however, is dependant on the simple mixing action within the hydraulic return flow (preferably within a concentric annular return portion of the reactor). In fact, the mass-transfer rates within the reactor as a whole are likely to be lowest in this region. In accordance with one aspect of the present invention, it is within the return tube where the greatest overall contribution can be made to improving mass-transfer rates (especially mass-transfer between solid/liquid phases), through improved mixing. The action of static mixers deployed in the return tube increases the effective mean path length of the solid phase and helps to keep the solid phase better suspended and mutually separated (so that the chances for physical agglomeration of the discrete elements of the solid phase are reduced).

In accordance with another aspect of the present invention, there is provided an improved reactor design in which improved radial shear-mixing is provided through the use of preferred static mixer elements. As a generalisation, typical static mixers include fluid redirecting tabs, vanes, baffles or the like, that are arranged in a fluid conduit, and which are typically operable to divide, subdivide, separate adjacent subdivided flows, and then recombine the subdivided flows into a “shuffled” whole, as the fluid passes through that conduit. In a departure from that more typical approach, U.S. Pat. No. 4,929,088 discloses a tab arrangement in a fluid conduit that has lower fluid back-pressures than are associated with the more typical approach to more typical static mixer designs. In particular, this patented tab arrangement operates by creating radial vortex flow patterns that are generally transverse to the longitudinal flow through the fluid conduit in which these tabs are mounted. This results in a plurality of cross-stream mixing flows that are transverse to the longitudinal flow of the fluid along the length of the conduit. This approach is disclosed as an enhancement over the kind of mixing that would be expected to naturally occur in a conduit under turbulent fluid flow conditions. Moreover, in U.S. Pat. No. 5,800,059, it is disclosed that including a central body in a photo-reactor can actually improve mixing associated with these known static mixer tabs—and in accordance with the present invention, this is particularly advantageous in annular return tubes surrounding a central draught tube in a gas lift reactor.

In accordance with the present invention there is provided an improvement in gas-lift reactors in which a central elongated draught (tube) conduit is deployed (generally concentrically) within the return conduit.

In a particularly preferred embodiment according to the present invention, there is provided a recirculating flow gas-lift bioreactor such as a fermentor, in which the return flow conduit includes tabs which are each arranged with respective, (preferably leading, upstream) edges adjacent the conduit wall, and respective, (preferably trailing, downstream) opposed edges that are spaced radially inwardly from the conduit wall. These tabs are operable as fluid foils which, with fluid flowing through the return tube, have greater fluid pressures manifest against their upstream faces and reduced fluid pressures against their downstream faces. This pressure difference in the fluid adjacent, respectively, the mutually opposed faces of each of the tabs then causes the longitudinal flow over and past each tab to be redirected, thereby resulting in the addition of a relatively persistent radial cross-flow component to the downstream longitudinal flow of fluid through the conduit.

In the preferred operation of one aspect of the present invention, the static mixing is performed over a longitudinal extent of a mixing volume having an annular cross-section. More specifically, this entails cross-stream mixing in a return tube fluid flow, in which the tabs mentioned herein redirect a longitudinal fluid flow from an outer, fluid containment boundary surface, across an intervening space having an annular cross-section towards an inner boundary surface. Preferably, the tabs are ramped and arranged in the fluid flow between the respective boundary surfaces, to cause the fluid to flow over the edges of each such tab to deflect the generally longitudinal fluid flow inwardly from the fluid containment boundary surface, across the intervening space (having the aforesaid annular cross-section), towards an inner boundary surface.

In a particularly preferred form the fluid flow over the edges of each tab results in the flow being deflected inward and up the inclined surface of the tab to generate a pair of tip vortices in the fluid flow past each tab. The vortices of each such pair have mutually opposed rotations, about an axis of rotation oriented generally along the longitudinal “stream-wise” or downstream fluid flow direction, along the annular space between the two boundary surfaces.

Generally, therefore, the present invention is related to a re-circulating flow reactor comprising conduits arranged to provide for a re-circulating fluid flow there between over the course of a statistical fluid residence period, and wherein an at least one of the conduits is a static mixer conduit including static mixer means. In an exemplary embodiment, the reactor is a gas-lift reactor—more particularly, a bioreactor, and the present invention is contemplated to have particular application with respect to a fermentor—which might be used in the production of beer, for example.

Preferably, the static mixer conduit is a re-circulating fluid flow “return” conduit.

As mentioned above, the static mixer conduit preferably comprises a longitudinally elongated conduit having static mixer means. The static mixer means advantageously comprise tabs that are arranged with respective first edges adjacent a wall surface defining the static mixer conduit. Respective, opposed second edges of the tabs, are spaced radially inwardly from the static mixer conduit wall. In this arrangement the tabs are operable as fluid foils which, with fluid flowing through static mixer conduit, have greater fluid pressures manifest against their upstream faces and reduced fluid pressures against their downstream faces, and wherein a resultant pressure difference in the fluid adjacent, respectively, the mutually opposed faces of each of the tabs causes a longitudinal flow of fluid through static mixer conduit over and past each said tab, to be redirected. The result is the induction of a relatively persistent radial cross-flow component to the downstream longitudinal flow of fluid through the static mixer conduit.

In connection with the present invention, a re-circulating flow, gas lift reactor is provided which comprises draught and return conduits that are co-operatively arranged to provide for a re-circulating fluid flow there between, over the course of a statistical fluid residence period. At least one of these mutually concentric conduits comprises a static mixer conduit—and preferably it is the “return” conduit. In either case, the static mixer conduit comprises a longitudinally elongated conduit having tabs. These tabs are arranged with respective first edges adjacent the static mixer conduit wall, and respective opposed second edges that are spaced radially inwardly from the static mixer conduit wall. The tabs are operable as fluid foils which, with fluid flowing through the static mixer conduit, to have greater fluid pressures manifest against their upstream faces and reduced fluid pressures (behind) against their downstream faces. The resultant pressure difference in the fluid adjacent, respectively, the mutually opposed faces of each of the tabs causes a longitudinal flow of fluid through the static mixer conduit over and past each of the tabs, to be redirected, thereby resulting in previously mentioned addition of a relatively persistent radial cross-flow component to the downstream longitudinal flow of fluid through the conduit.

Preferably the reactor of the present invention is comprised of an inter-nested arrangement of conduits. In an exemplary inter-nested arrangement of conduits for the present purposes, there are mutually-concentric conduits defining an at least one annular conduit in a space there between—all arranged to provide for a re-circulating fluid flow between the respective conduits, over the course of a statistical fluid residence period. In a particularly preferred form, the present invention is a continuous reactor, in which a certain proportion of the contents of the reactor volume is continuously drawn off, and replaced by a corresponding proportion of new contents. In the case of beer production for example, a certain amount of fermented beer is drawn off from the reactor, continuously, while a corresponding amount of unfermented wort is added. The proportionate turnover of the reactor volume is a function of the statistical residence time required, on average, to convert unfermented wort to beer within the reactor under the given operating conditions. The residence time is “statistical” in the sense that any particular “fluid element” of wort or beer may reside for a shorter or longer period of time—but the average residence period is sufficient to produce a predetermined degree of reaction (e.g. conversion oc wort to beer).

Preferably, the inter-nested reactor is such that at least one of the mutually concentric conduits comprises a static mixer conduit comprising a longitudinally elongated conduit having tabs that are arranged with respective first edges adjacent the static mixer conduit wall, and respective opposed second edges that are spaced radially inwardly from the static mixer conduit wall. As has already been mentioned, in this arrangement, these tabs are operable as fluid foils which, with fluid flowing through the static mixer conduit, have greater fluid pressures manifest against their upstream faces and reduced fluid pressures against their downstream faces. The resultant pressure difference in the fluid adjacent, respectively, the mutually opposed faces of each of the tabs causes a longitudinal flow of fluid through said static mixer conduit over and past each said tab, to be redirected, thereby resulting in the addition of a relatively persistent radial cross-flow component to the downstream longitudinal flow of fluid through the conduit.

Preferably the conduit that is equipped with these tabs is the annular conduit, and it is especially preferred that it be a return conduit.

The present invention also extends to the method of operating a re-circulating flow reactor to induce static mixing over a longitudinal extent of a mixing volume having an annular cross-section, wherein radial cross-stream mixing in a longitudinal fluid flow results from flow-redirecting tabs redirecting a longitudinal fluid flow from an outer, fluid containment boundary surface, across an intervening space having an annular cross-section towards an inner boundary surface. Preferably, this method is used in the operation of a gas lift reactor—and particularly in the return conduit thereof. The application of the present method is especially useful in relation to bioreactors, and in particular, fermentors, as in the case of beer and other alcoholic beverage production. In any case, the present method is preferably carried out with the tabs arranged in the fluid flow between the respective boundary surfaces, to cause the fluid to flow over the edges of each tab to deflect the generally longitudinal fluid flow inwardly from the fluid containment boundary surface, across the intervening annular space towards the inner boundary surface. In a particularly preferred practice, the fluid flow over the edges of each tab results in the flow being deflected inwardly and upwardly along an inclined surface of each tab, to thereby generate a pair of tip vortices in the fluid flow past each tab. The vortices associated with each such pair have mutually opposed rotations about an axis of rotation oriented generally along the longitudinal “stream-wise” fluid flow direction, along the annular space between the two boundary surfaces that define the annular return conduit.

Introduction to the drawings:

FIG. 1 is an elevated, longitudinal cross-section through a reactor according to one aspect of the present invention;

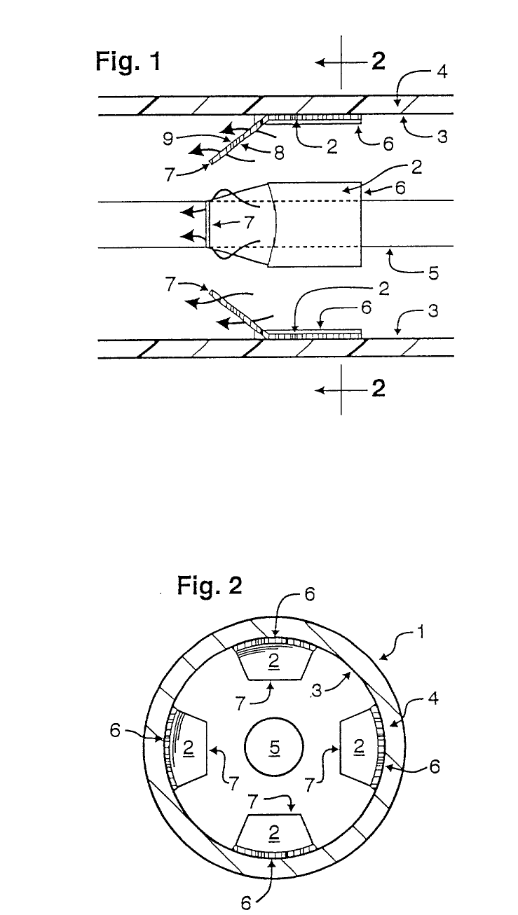

FIG. 2 is an elevated, transverse cross-section taken through line 2-2 of the reactor depicted in FIG. 1;

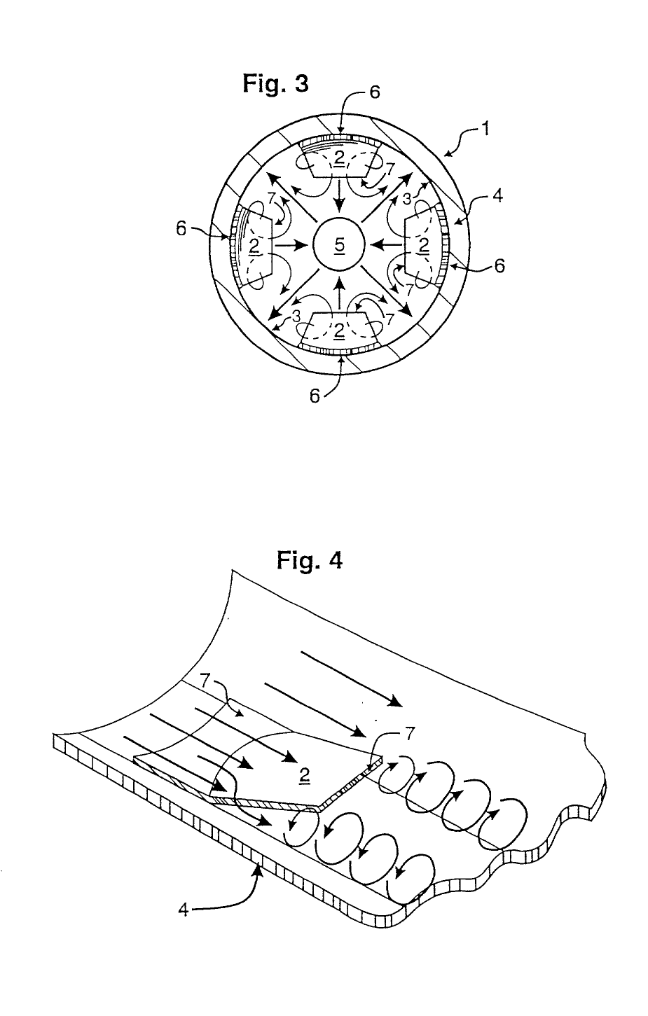

FIG. 3 is a reproduction of the view illustrated in FIG. 2, but further including representative fluid stream lines, to illustrate radial cross-flow patterns; and,

FIG. 4 is a cut-away perspective view illustrating vortex flow downstream of a single, representative tab; and,

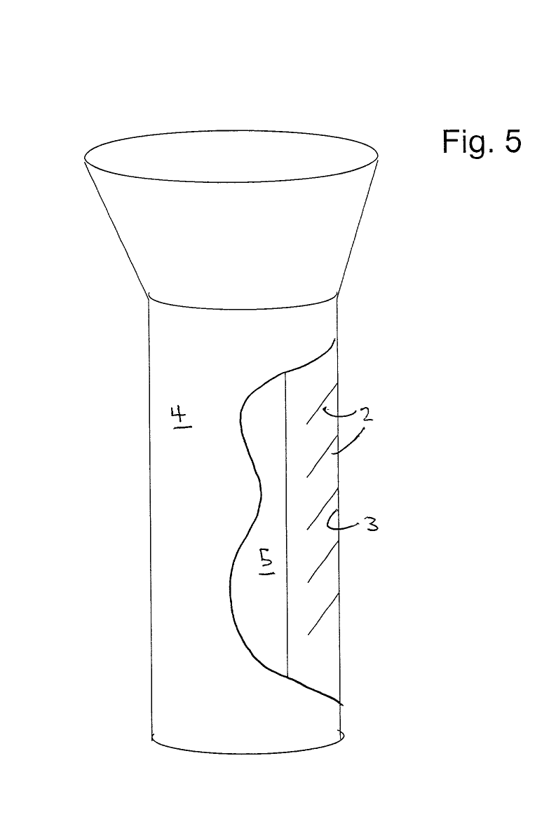

FIG. 5 is a cut-away perspective view of a preferred reactor according to the present invention.

### DETAILED DESCRIPTION AND A PREFERRED EMBODIMENT OF THE PRESENT INVENTION

(Note: The apparatus disclosed and illustrated in U.S. Pat. No. 4,929,088—Smith, (dated Mar. 29, 1990), is useful as a component of the present invention, and the disclosure of that patent is hereby expressly incorporated herein, in its entirety. Similarly, the method described in U.S. Pat. No. 4,981,368—Smith, (dated Jan. 1, 1991), and the disclosure of U.S. Pat. No. 5,800,059, McGarrity et al, are also hereby expressly incorporated herein, in their entirety.

Referring now to FIGS. 1, 2 and 3, there is illustrated an embodiment according to the present invention, in which a static mixer 1, includes a series of tabs 2 that are secured to the side walls 3 of a conduit 4. A draught tube 5 is arranged in co-axially aligned relation, centrally within the interior of conduit 4, where it occupies a region of what would otherwise be inefficient mixing.

In the illustrated embodiment, that region forms between diametrically-opposed, radially-convergent, cross-stream mixing flows (see FIG. 3, in particular) within conduit 4.

Static mixer 1 comprises conduit 4, in which tabs 2 are each arranged with respective, (leading, upstream) edges 6 adjacent the conduit wall, and respective, (trailing, downstream) opposed edges 7 that are spaced radially inwardly from the conduit wall 3. Tabs 2 operate as fluid foils which, with fluid flowing through the mixer, have greater fluid pressures manifest against their upstream faces 8 (see FIG. 1) and reduced fluid pressures against their downstream faces 9 (see FIG. 1). This pressure difference in the fluid adjacent, respectively, the mutually opposed faces of each of the tabs then causes the longitudinal flow over and past each tab to be redirected (as is illustrated by the various flow streamlines that are shown in the various figures), thereby resulting in the addition of a radial cross-flow component to the longitudinal flow of fluid through the conduit 4.

With draft tube 5 occupying the zone, which but for the presence of the draft tube would be a zone of relatively poor mixing as described above, the fluid itself is precluded from forming eddies in that zone, in which the fluid would not be as thoroughly admixed with the balance of the fluid flow.

In operation, the improved static mixing according to the present invention is performed over a longitudinal extent of a mixing volume having an annular cross-section, located between the draught tube 5 and side walls 3 of conduit 4. More specifically, there is cross-stream mixing in the longitudinal fluid flow through the present apparatus, in which tabs 2 redirect a longitudinal fluid flow from the outer, fluid containment boundary surface of side walls 3, across an intervening space having an annular cross-section towards the inner boundary surface defining the outermost extent of draught tube 5. Preferably, tabs 2 are ramped and arranged in the fluid flow between the respective boundary surfaces of side walls 3 and draught tube 5, to cause the fluid to flow over the edges of each tab 2 to deflect the generally longitudinal fluid flow radially inwardly from the fluid containment boundary surface of side wall 3, across the intervening space (having the aforesaid annular cross-section), towards an inner boundary surface defined by the outermost surface of draught tube 5. The inner boundary surface of draught tube 5, circumscribes a volume which but for the presence of that surface, would permit passage of a central longitudinal flow of substantial, relatively non-uniform mixing.

In a particularly preferred form the fluid flow over the edges of each tab results in the flow being deflected inward and up the inclined surface of the tab to generate a pair of tip vortices in the fluid flow past each tab. The vortices of each such pair have mutually opposed rotations, about an axis of rotation oriented generally along the longitudinal “stream-wise” fluid flow direction, along the annular space between the two boundary surfaces.

1. A re-circulating flow reactor comprising conduits arranged to provide for a re-circulating fluid flow there between over the course of a statistical fluid residence time, and wherein an at least one of said conduits is a static mixer conduit including static mixer means.

2. The reactor according to claim 1, wherein said reactor is gas-lift reactor.

3. The reactor according to claim 2, wherein said reactor is a bioreactor.

4. The reactor according to claim 3, wherein said reactor is a fermentor.

5. The reactor according to claim 4, wherein said static mixer conduit is a return conduit.

6. The reactor according to claim 1, wherein said static mixer conduit comprises a longitudinally elongated conduit having static mixer means comprising tabs that are arranged with respective first edges adjacent a wall surface defining said static mixer conduit, and respective opposed second edges that are spaced radially inwardly from said static mixer conduit wall, wherein said tabs are operable as fluid foils which, with fluid flowing through said static mixer conduit, have greater fluid pressures manifest against their upstream faces and reduced fluid pressures against their downstream faces, and wherein a resultant pressure difference in the fluid adjacent, respectively, the mutually opposed faces of each of the tabs causes a longitudinal flow of fluid through said static mixer conduit over and past each said tab, to be redirected, thereby inducing a radial cross-flow component to the longitudinal flow of fluid through the static mixer conduit.

7. A re-circulating flow, gas lift reactor comprising draught and return conduits, co-operatively arranged to provide for a re-circulating fluid flow there between, over the course of a statistical fluid residence period, and wherein an at least one of said mutually concentric conduits comprises a static mixer conduit.

8. The reactor according to claim 7, wherein said static mixer conduit is the return conduit.

9. The reactor according to claim 8 wherein said static mixer conduit comprises a longitudinally elongated conduit having tabs that are arranged with respective first edges adjacent the static mixer conduit wall, and respective opposed second edges that are spaced radially inwardly from the static mixer conduit wall, wherein said tabs are operable as fluid foils which, with fluid flowing through said static mixer conduit, have greater fluid pressures manifest against their upstream faces and reduced fluid pressures against their downstream faces, and wherein a resultant pressure difference in the fluid adjacent, respectively, the mutually opposed faces of each of the tabs causes a longitudinal flow of fluid through said static mixer conduit over and past each said tab, to be redirected, thereby resulting in the addition of a radial cross-flow component to the longitudinal flow of fluid through the conduit.

10. The reactor according to claim 1, comprising an inter-nested arrangement of conduits.

11. The reactor according to claim 10, wherein said inter-nested arrangement of conduits comprises mutually-concentric conduits defining an at least one annular conduit in a space there between, and arranged to provide for a re-circulating fluid flow between said conduits for a statistical fluid residence period.

12. The reactor according to claim 11, wherein an at least one of said mutually concentric conduits comprises a static mixer conduit comprising a longitudinally elongated conduit having tabs that are arranged with respective first edges adjacent the static mixer conduit wall, and respective opposed second edges that are spaced radially inwardly from the static mixer conduit wall, wherein said tabs are operable as fluid foils which, with fluid flowing through said static mixer conduit, have greater fluid pressures manifest against their upstream faces and reduced fluid pressures against their downstream faces, and wherein a resultant pressure difference in the fluid adjacent, respectively, the mutually opposed faces of each of the tabs causes a longitudinal flow of fluid through said static mixer conduit over and past each said tab, to be redirected, thereby resulting in the addition of a radial cross-flow component to the longitudinal flow of fluid through the conduit.

13. The reactor according to claim 12, wherein said at least one of said mutually concentric conduits includes said annular conduit.

14. The reactor according to claim 13, wherein said annular conduit is a return conduit.

15. The reactor according to claim 14, wherein said reactor is a bioreactor.

16. The reactor according to claim 15, wherein said reactor is a fermentor.

17. A method comprising static mixing in a re-circulating flow reactor, over a longitudinal extent of a mixing volume having an annular cross-section, wherein radial cross-stream mixing in a longitudinal fluid flow results from flow-redirecting tabs redirecting a longitudinal fluid flow from an outer, fluid containment boundary surface, across an intervening space having an annular cross-section towards an inner boundary surface.

18. The method according to claim 17, wherein said reactor is a gas lift reactor.

19. The method according to claim 18, wherein said static mixing is carried out in a return conduit of said reactor.

20. The method according to claim 18, wherein said reactor is a bioreactor.

21. The method according to claim 20, wherein said reactor is a fermentor.

22. The method according to claim 21, wherein said tabs are ramped and arranged in the fluid flow between the respective boundary surfaces, to cause the fluid to flow over the edges of each said tab to deflect the generally longitudinal fluid flow inwardly from the fluid containment boundary surface, across the intervening annular space towards said inner boundary surface.

23. The method according to claim 22, wherein the fluid flow over the edges of each said tab results in the flow being deflected inwardly and upwardly along an inclined surface of each said tab, to thereby generate a pair of tip vortices in the fluid flow past each tab, and wherein said vortices associated with each said pair have mutually opposed rotations about an axis of rotation oriented generally along the longitudinal “stream-wise” fluid flow direction, along the annular space between said two boundary surfaces.
